(19) United States
(12) Patent Application Publication
(10) Pub. No.: US 2005/0099734 A1
(43) Pub. Date: May 12, 2005

(54) Distributed damper for data storage devices

(76) Inventor: Menachem Rafaelof, Superior, CO (US)

Correspondence Address: Derek J. Berger;Seagate Technology LLC, Intellectual Property-COL2LGL, 389 Disc Drive, Longmont, CO, 80503, US

(21) Appl. No.: 10/702,888

(22) Filed: Nov. 6, 2003

(51) Int. Cl. G11B 33/14; G11B 5/55; G11B 21/08

(52) U.S. Cl. 360/264.8; 360/97.02

(57) ABSTRACT

According to one embodiment, a data storage device has a base deck and a cover mounted on the base deck. A Voice Coil Motor (VCM) is mounted on the base deck below the cover. The VCM has a lower magnetic plate mounted on bosses extending from the base deck and an upper magnetic plate mounted on the lower magnetic plate. A damper is positioned between the upper magnetic plate of the VCM and the cover. The damper comprises a plurality of contact points distributed across the upper magnetic plate. The contact points extend between the upper magnetic plate of the VCM and the cover. Alternatively, a damper is positioned between the lower magnetic plate of the VCM and the base deck. The damper comprises a plurality of contact points distributed across the lower magnetic plate. The contact points extend between the lower magnetic plate of the VCM and the base deck.

### FIELD OF THE INVENTION

The invention is generally directed to the field of data storage devices and more particularly to controlling vibration and acoustic noise emissions from a data storage device.

### BACKGROUND OF THE INVENTION

Data storage devices are conventionally used to store electronic data. One common type of data storage device is a disc drive. Disc drives typically include one or more discs on which data is stored. The discs may store data in a variety of formats; for example, the discs in hard disc drives may be coated with a magnetizable medium and mounted on the hub of a spindle motor for rotation at a constant high speed. Information may be stored on the discs in a plurality of concentric circular tracks. Data may be written to, and read from, the tracks via transducers (“heads”) mounted to a radial actuator, which positions the heads relative to the discs.

Typically, such radial actuators employ a voice coil motor (VCM) to position the heads with respect to the disc surfaces. The heads are mounted via flexures at the ends of a plurality of arms which project radially outward from a substantially cylindrical actuator body. The actuator body pivots about a shaft mounted to the disc drive housing at a position closely adjacent the outer extreme of the discs. The pivot shaft is parallel with the axis of rotation of the spindle motor and the discs, so that the heads move in a plane parallel with the surfaces of the discs.

In one typical arrangement, the VCM includes a coil mounted on the side of the actuator body opposite the head arms between an array of permanent magnets which are held above and/or below the coil on upper and/or lower magnet plates, respectively. When controlled current is passed through the coil, an electromagnetic field is generated. The generated electromagnetic field interacts with the magnetic field of the permanent magnets thus causing the coil to move relative to the magnets in accordance with the well-known Lorentz relationship. As the coil moves, the actuator body pivots about the pivot shaft and the heads are moved across the disc surfaces.

Typically, the heads are supported on the actuator arms in a position over the discs by actuator slider assemblies which include air-bearing surfaces designed to interact with a thin layer of moving air generated by the rotation of the discs, so that the heads may “fly” over the disc surfaces. Generally, the heads write data to a selected data track on the disc surface by selectively magnetizing portions of the data track through the application of a time-varying write current to the head. In order to subsequently read back the data stored on the data track, the head detects flux transitions in the magnetic fields of the data track and converts these flux transitions to a signal which is decoded by read channel circuitry of the disc drive.

A closed-loop servo system may be used to control the position of the heads with respect to the disc surfaces. More particularly, during a track following mode in which a head is caused to follow a selected data track, servo information is read which provides a position error signal indicative of the position of the head relative to a centerline of the track. The position error signal is used, when necessary, to generate a correction signal that in turn is provided to a power amplifier. The power amplifier then passes current through the actuator coil to adjust the position of the head relative to the track.

During a seek operation, the servo system receives the address of the destination track and generates control signals that cause the heads to initially accelerate and then subsequently decelerate as the head nears the destination track. At some point towards the end of the deceleration of the head, the servo system will transition to a settle mode during which the head is settled onto the destination track and, thereafter, the servo system causes the head to follow the destination track in a track following mode.

Generally, the objective of a typical seek operation has been to move the head from the initial track to the destination track in a minimum amount of time (access time). However, one drawback associated with rapidly moving heads to the destination track is the occurrence of mechanical vibrations excited in the upper and/or lower magnet plates during the seek operation. These vibrations may induce noise into the servo control loop of the disc drive, thus making accurate track following difficult. As will be understood, the negative affects of vibration-induced noise in the servo system are compounded as the track density or tracks per inch (TPI) of the disc drive is increased. The general trend in the disc drive industry is to produce disc drives having ever increasing TPI. As such, it is imperative that new methods and techniques are developed to address vibration-induced servo system noise. Additionally, these vibrations can generate excessive acoustic noise emissions from the disc drive.

For the moving components, the vibration and hence acoustic emission is mostly controlled by use of seek algorithms to either attenuate the level of excitation or prevent excitation at the nature resonance modes of the structure (e.g. resonance modes of the coil). While this approach is beneficial, it cannot fully suppress the vibration and the acoustic emission by the primary stationary structures. This is due to the fact that the stationary parts have different modes of vibration while facilitating a path of vibration for other components (i.e. the base and the cover).

One way to minimize the vibration of primary stationary parts is to constrain the VCM plates with a maximum number of screws. This approach is costly and sometimes not possible due to lack of space for screws and assembly requirements using automated processes.

Another approach to reducing vibration and acoustical emissions from the disc drive is to use mechanical dampers. Discrete dampers such as a thin slab of rubber type material have been used in many products. Examples of such discrete dampers include the use of EPDM, Dyeon or other materials with a high loss factor between the base plate of the drive and the surface of the lower plate of the VCM or between the cover and upper VCM plate. For this approach to be effective, the top cover must be sufficiently rigid to provide deflection of the damping material. However, the stiffness required for this approach to be useful often adds unacceptable weight and manufacturing costs to the disc drive.

The use of current dampers is limited by the high cost of these materials and the localized benefit they offer. Current dampers have additional limitations when used in smaller mobile and desktop drives with very thin covers. Due to the presence of small gaps and high stiffness of the damper, inclusion of the damper in these drives results in the deformation of the cover causing the drive to leak and/or violate form factor envelope dimension requirements.

Accordingly there is a need for a disc drive damping system and/or method which effectively reduces VCM vibrations in a disc drive and, thereby, reduces acoustical emissions and vibration-induced noise in the disc drive's servo system.

### SUMMARY OF THE INVENTION

Against this backdrop the present invention has been developed. According to one embodiment of the present invention, a disc drive has a base deck and a cover mounted on the base deck above the upper surface of the base deck. A Voice Coil Motor (VCM) is mounted on the upper surface of the base deck, below the cover. The VCM has a lower magnetic plate mounted on a plurality of bosses extending above the upper surface of the base deck and an upper magnetic plate mounted on the lower magnetic plate.

A vibration damper is placed between a surface of a magnetic plate and an adjacent surface of the disc drive support structure such as the base deck and cover. In one aspect of the invention a damper is positioned between the upper surface of the upper magnetic plate of the VCM and the inside surface of the cover. The damper comprises a plurality of contact points distributed across the upper surface of the upper magnetic plate. The contact points extend between the upper surface of the upper magnetic plate of the VCM and the inside surface of the cover.

Another aspect of the present invention includes a damper positioned between the lower surface of the lower magnetic plate of the VCM and the upper surface of the base deck. The damper comprises a plurality of contact points distributed across the lower surface of the lower magnetic plate. The contact points extend between the lower surface of the lower magnetic plate of the VCM and the upper surface of the base deck.

Another aspect of the invention includes a method of forming a distributed damper for a disc drive. The method comprises depositing liquid Form In Place Gasket (FIPG) material onto a surface to form a plurality of contact points. The plurality of contact points provide contact between a Voice Coil Motor (VCM) of the disc drive and another component of the disc drive. The liquid FIPG material is then cured to form a solid damper.

These and various other features as well as advantages which characterize the present invention will be apparent from a reading of the following detailed description and a review of the associated drawings.

### BRIEF DESCRIPTION OF THE DRAWINGS

The appended claims set forth the features of embodiments of the invention with particularity. The invention, together with its advantages, may be best understood from the following detailed description taken in conjunction with the accompanying drawings of which:

FIG. 1 is a plan view showing the primary internal components of a disc drive in which embodiments of the present invention may be incorporated;

FIG. 2 is an isometric view of a disc drive base deck illustrating an exploded view of a Voice Coil Motor (VCM) assembly with mechanical dampers of the present invention installed;

FIG. 3A is a side view of a molded damper according to one embodiment of the present invention;

FIG. 3B is a bottom view of a molded damper according to one embodiment of the present invention;

FIG. 4 is a cross-sectional side view of a Voice Coil Motor (VCM) assembly mounted in an assembled disc drive with installed molded dampers according to one embodiment of the present invention;

FIG. 5A is a side view of a self-adhesive damper according to one embodiment of the present invention;

FIG. 5B is a bottom view of a self-adhesive damper according to one embodiment of the present invention;

FIG. 6 is a cross-sectional side view of a Voice Coil Motor (VCM) assembly mounted in an assembled disc drive with an installed self-adhesive damper according to one embodiment of the present invention;

FIG. 7 is a bottom view of a disc drive cover with a plurality of contact points comprising a damper according to one embodiment of the present invention; and

FIG. 8 is a cross sectional side view of a Voice Coil Motor (VCM) assembly mounted in an assembled disc drive with a plurality of contact points comprising a damper according to one embodiment of the present invention.

### DETAILED DESCRIPTION

In the following description, for the purposes of explanation, numerous specific details are set forth in order to provide a thorough understanding. It will be apparent, however, to one skilled in the art that embodiments of the present invention may be practiced without some of these specific details. In other instances, well-known structures and devices are shown in block diagram form.

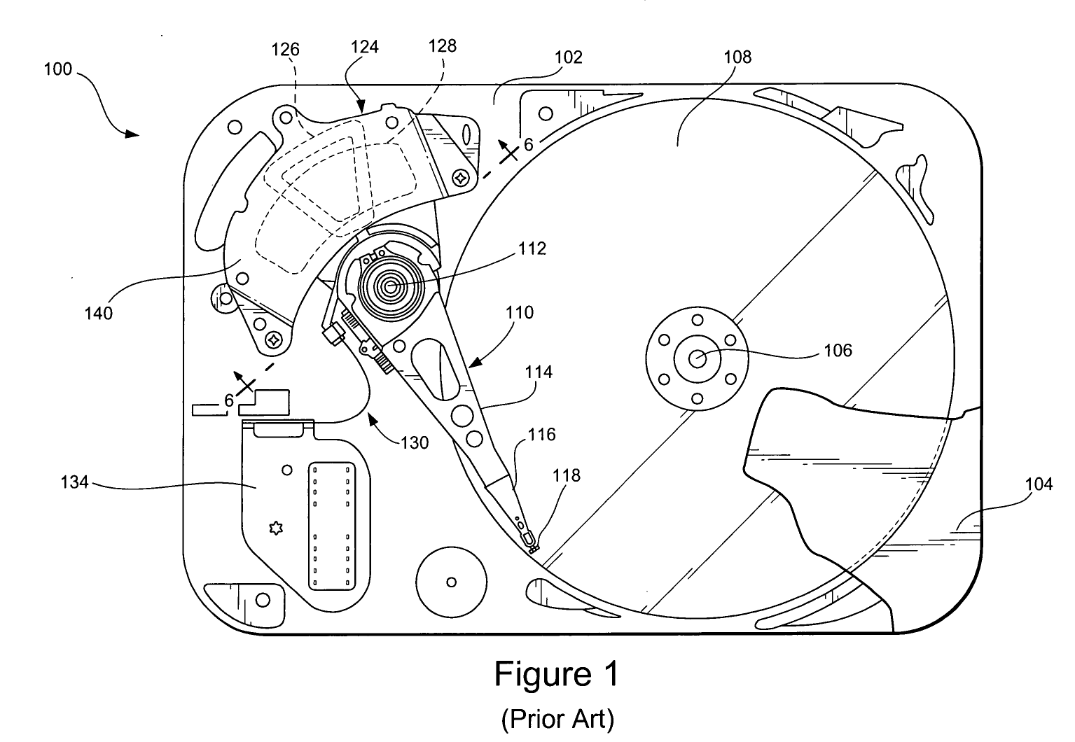

FIG. 1 is a plan view showing the primary internal components of one example of a disc drive in which embodiments of the present invention may be incorporated. Referring to FIG. 1, a disc drive 100 in which the methods and system of the present invention may be practiced is shown. The disc drive 100 includes a base plate 102 to which various components of the disc drive 100 are mounted. A top cover 104, shown partially cut away, cooperates with the base plate 102 to form an internal, sealed environment for the disc drive in a conventional manner. The components include a spindle motor 106 which rotates one or more discs 108 at a constant high speed. Information is written to, and read from, tracks on the discs 108 through the use of an actuator assembly 110, which rotates during a seek operation about a bearing shaft assembly 112 positioned adjacent the discs 108. The actuator assembly 110 includes a plurality of actuator arms 114 which extend toward and over the discs 108, with one or more flexures 116 extending from each of the actuator arms 114. Mounted at the distal end of each of the flexures 116 is a head 118 which includes an air bearing slider (not shown) that enables the head 118 to fly in close proximity to a corresponding surface of an associated disc 108.

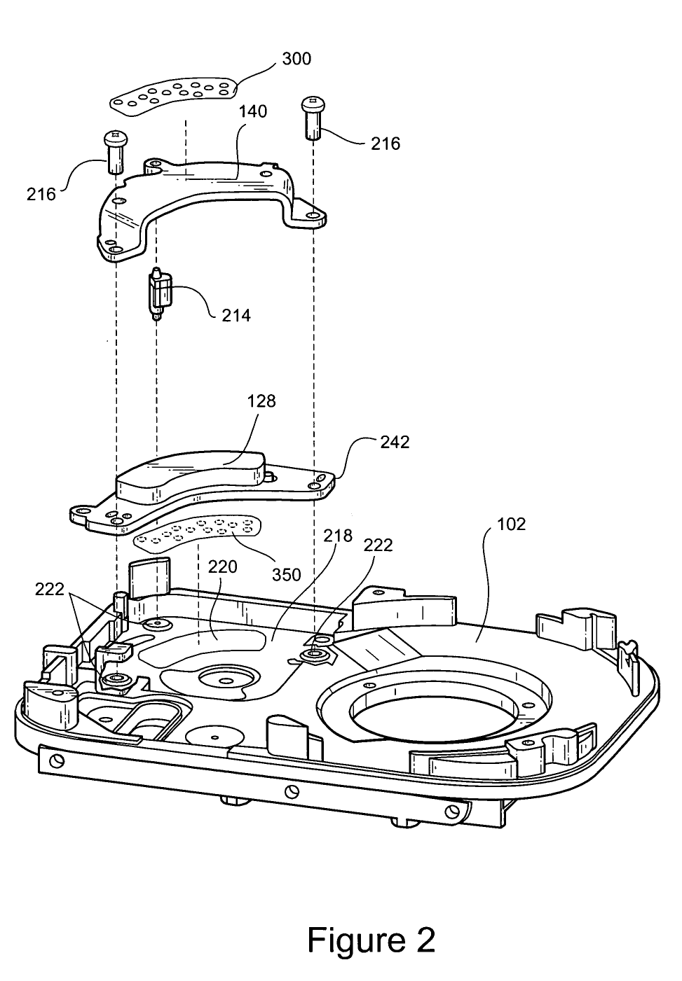

During a seek operation, the track position of the heads 118 is controlled through the use of a voice coil motor (VCM) 124, which typically includes a coil 126 attached to the actuator assembly 110, an upper magnet plate 140, a lower magnet plate 242 (see FIG. 2), as well as one or more pairs of permanent magnet pairs 128 which establish a magnetic field in which the coil 126 is immersed. The controlled application of current to the coil 126 causes magnetic interaction between the magnet pair(s) 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

A flex assembly 130 provides the requisite electrical connection paths for the actuator assembly 110 while allowing pivotal movement of the actuator assembly 110 during operation. The flex assembly typically includes circuitry to which head wires (not shown) are connected. The head wires are routed along the actuator arms 114 and the flexures 116 to the heads 118. The flex assembly circuitry typically controls the write currents applied to the heads 118 during a write operation and amplifies read signals generated by the heads 118 during a read operation. The flex assembly terminates at a flex bracket 134 for communication through the base 102 to a disc drive printed circuit board (not shown) mounted to the bottom side of the disc drive 100.

FIG. 2 is an isometric view of a disc drive base deck illustrating an exploded view of a Voice Coil Motor (VCM) assembly with mechanical dampers 300,350 of the present invention installed. This example illustrates only selected components including the base plate 102, the lower magnetic plate 242, the upper magnetic plate 140, an optional lower damper pad 210, an optional upper damper pad 211, the permanent magnet pair 128, a spacer 214, and a number of screws 216 that hold the upper magnet plate to the lower magnet plate and the VCM 124 to the base plate 102. As shown in FIG. 2, the base plate 102 includes an optional damper pad pocket 220 into which the lower damper pad 350 may be inserted and held. As also shown in FIG. 2, a number of bosses 222 may be located on, or may be integral with, the base plate 102, extend above an upper surface 218 of the base plate 102 and act as spacers, such that when the lower magnet plate 242 is attached to the base plate 102, the lower magnet plate is held a distance above the upper surface 218 of the base plate 102.

The lower damper pad 350, if used, may be positioned between the lower magnet plate 242 and the base plate 102 of the disc drive 100. Positioned in this manner, the lower damper pad 210 is “pinched” between the lower magnet plate 242 and the base plate 102 during assembly of the disc drive 100. The lower damper pad 350 may be positioned within the damper pad pocket 220 on the upper surface 218 of the base plate 102. The damper pad pocket 220 may comprise a recessed area in the upper surface 218 of the base plate 102, located centrally under the lower magnet plate 242. The lower damper pad pocket 220 acts as a guide for placement of the lower damper pad 350 during assembly of the disc drive 100.

The upper damper pad 300, if used, may be positioned between the upper magnetic plate 140 and the cover (not shown) of the disc drive 100. Positioned in this manner, the upper damper pad 300 is “pinched” between the upper magnet plate 140 and the cover (not shown) during assembly of the disc drive 100.

The lower damper pad 350 is of sufficient overall thickness to fit snugly between the lower magnet plate 242 and the base plate 102 in a manner which allows the damper pad 350 to touch both the bottom surface of the lower magnet plate 242 and the upper surface of the base plate 102, without causing the damper pad 350 to experience excessive compressive forces which would render the pad 350 ineffective to dampen vibrations. Similarly, the upper damper pad 300 is of sufficient overall thickness to fit snugly between the upper magnet plate 140 and the cover (not shown) without causing the damper pad 300 to experience excessive compressive forces which would render the pad 300 ineffective to dampen vibrations or to deflect the cover outward.

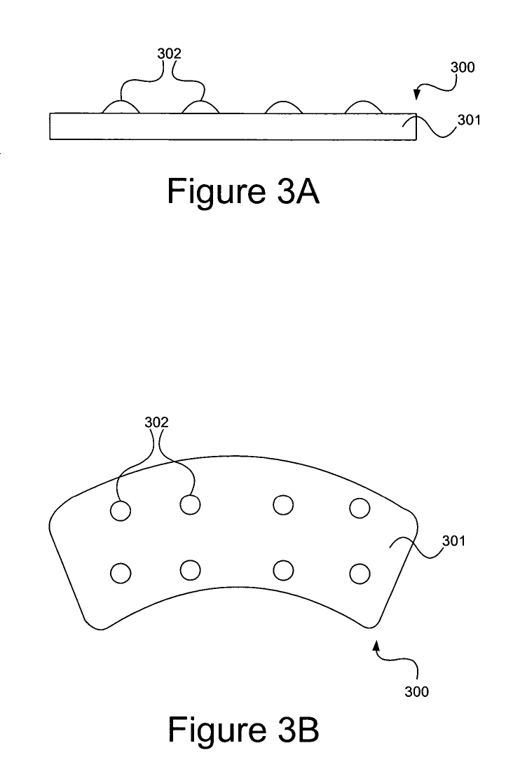

FIG. 3A is a side view of a molded damper according to one embodiment of the present invention. This example illustrates the molded damper 300 comprising a thin, flat base section 301 and a plurality of contact points 302 extending above the base section 301. As illustrated in this example, the plurality of contact points 302 appear as a number of bumps or dome-shaped protuberances. However, the exact shape of the contact points 302 may vary significantly. Alternative embodiments may utilize contact points 302 that are not dome shaped. For example, contact points molded into the damper 300 and extending above the base section 301 may be cylindrical, square, rectangular, etc.

Regardless of the exact shape of the contact points 302, molding the damper 300 to include a plurality of contact points 302 extending above a relatively thin base section 301 allows the molded damper 300 to use less material than a comparably sized block of uniform thickness as used in prior art dampers. Additionally, the contact points may be more easily compressed than a solid block of similar materials. Therefore, such a molded damper 300 may be made to cover a larger surface of a VCM assembly while maintaining material costs by distributing the plurality of contact points across the surface of the VCM assembly.

FIG. 3B is a bottom view of a molded damper according to one embodiment of the present invention. In this example the shape of the base section 301 of the molded damper 300 is more apparent. Here, the base section 301 of the molded damper 300 is shaped to conform to the shape of the surface of the VCM to which the molded damper 300 will be applied. For example, if the molded damper 300 is to be installed between the upper magnetic plate 140 and the cover 104 of the disc drive 100, the base section 301 of the molded damper 300 may be shaped and sized to conform to the top surface of the upper magnetic plate 140. However, the exact size and shape of the base section 301 of the molded damper 300 may vary significantly depending on cost, manufacturing, and other concerns.

The plurality of contact points 302 can be seen distributed across the top of the base section 301. As discussed above, even though the contact points are shown here to be dome-shaped, it is conceived that other shapes may be utilized. Additionally, the location and spacing of the contact points 302 may vary significantly. According to one embodiment of the present invention, the contact points 302 are placed arbitrarily and randomly across the top of the base section 301 of the molded damper 300. Alternatively, the contact points 302 may be located at even intervals with a fixed spacing between each. Regardless of the exact location and spacing of the contact points 302, a plurality of contact points 302 are distributed across the top surface of the base section 301.

The plurality of contact points 302 and the base section 301 of the molded damper 300 may be molded as a single piece. Materials used to form the molded damper 300 may include any of a variety of materials with characteristics suitable for use to dampen vibrations in an environment and at temperatures common in a disc drive. Suitable characteristics include cleanliness and low outgassing, a high loss factor, and stiffness. A preferred range for loss factor may include a loss factor of greater than 0.75 at a temperature from 25 to 37 degrees Celsius. Preferred stiffness may be considered a compression modulus from 1 to 3 MPa. Materials with characteristics beyond these ranges may be useful in certain situations. Therefore, various elostomers may be suitable for use as a molded damper. Examples of materials with these characteristics that may be suitable for use as in a molded damper include but are not limited to ethylene propylene (EPDM), fluorocarbons (FKM), materials commonly used as Form in Place Gasket (FIPG) materials such as silicons, urethanes, etc., and other elastomers such as natural rubber, nitrile rubber, neoprene, butyl, etc.

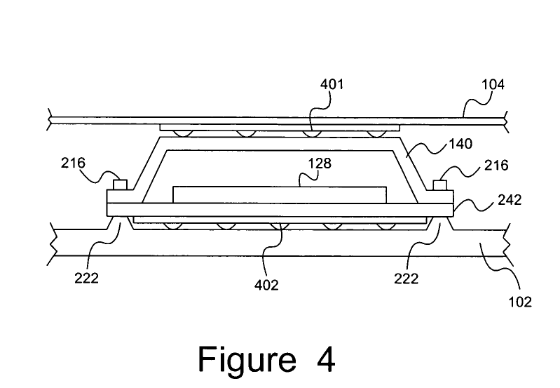

FIG. 4 is a cross-sectional side view of a Voice Coil Motor (VCM) assembly mounted in an assembled disc drive with installed molded dampers according to one embodiment of the present invention. This example illustrates a base deck 102, a lower magnetic plate 242, an upper magnetic plate 140, and a cover 104. The lower magnetic plate 242 is mounted on top of bosses 222 extending from the base plate 102. Mounted on the lower magnetic plate 242 is the permanent magnet pair 128. The upper magnetic plate 140 is mounted on top of the lower magnetic plate 242. Screws 216 pass through the upper magnetic plate 140 and the lower magnetic plate 242 and engage complementary threads (not shown) inside the bosses 222 to secure the upper magnetic plate 140 and the lower magnet plate 242 to the base deck 102. The cover 104 will mate with the base deck 102 at its edges (not shown) to seal the assembled disc drive 100. Typically the cover 104, when installed on the assembled disc drive 100, will be in close proximity to the top of the upper magnetic plate 140.

The example illustrated in FIG. 4 shows two molded dampers 401 and 402 according to one embodiment of the present invention. One molded damper, the upper molded damper 401, is shown positioned between and contacting the upper magnetic plate 140 and the cover 104. The other molded damper, the lower molded damper 402, is shown positioned between and contacting the lower magnetic plate 242 and the base deck 102 between the bosses 222. Alternatively, only one molded damper 401 or 402 may be used in a particular application. For example, only an upper molded damper 401 may be installed on a particular type of disc drive. Alternatively, only a lower molded damper 402 may be installed on another type of disc drive. However, using both, the upper molded damper 401 and the lower molded damper 402 may improve shock performance of the assembled drive. Therefore, using both the upper molded damper 401 and the lower molded damper 402 may be especially useful for disc drives installed in mobile devices.

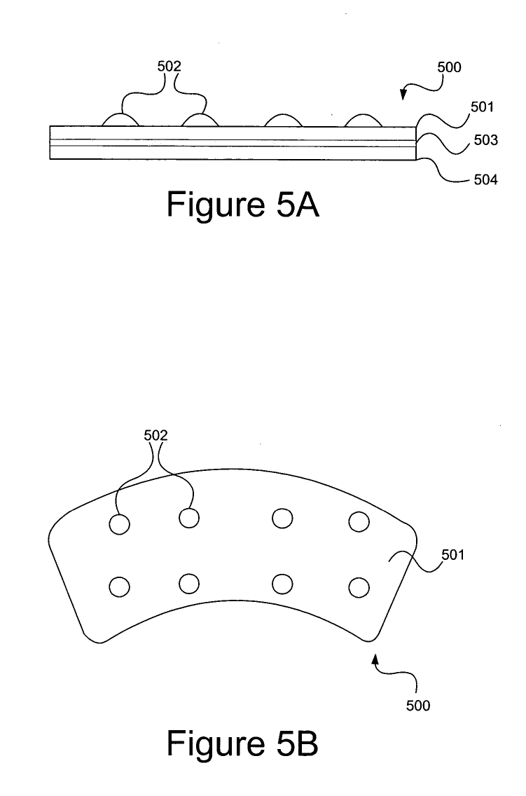

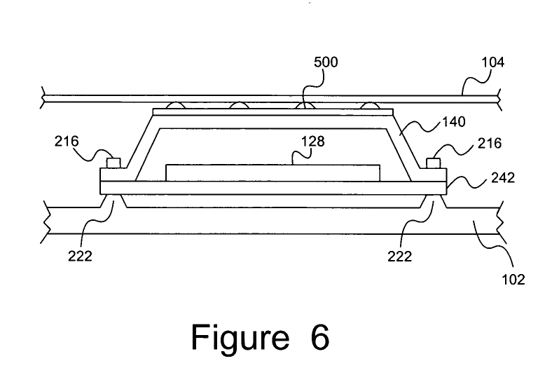

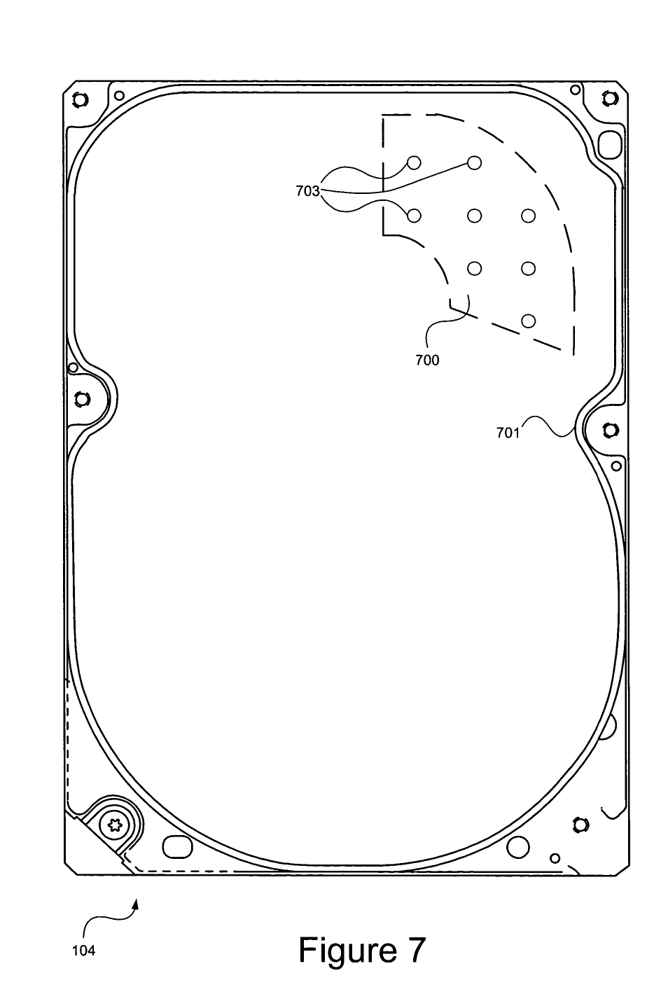

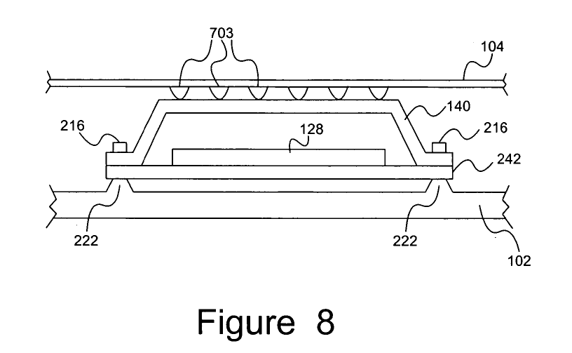

Additionally, either the upper molded damper 401 or the lower molded damper 402 may be used in combination with another type of damper including those disclosed herein. For example, a molded damper may be used in combination with a self-adhesive damper discussed below with reference to FIGS. 5 and 6 or with another alternative discussed below with reference to FIGS. 7 and 8.

According to one embodiment of the present invention, the lower molded damper 402 may also be used to isolate the lower magnet plate 242 from the base deck 102 by extending across the bosses 222 rather than between the bosses 222. In this embodiment, the lower molded damper 402 will be compressed between the lower magnetic plate 242 and the top of the bosses 222. Such isolation of the VCM from the bosses 222 and base deck 102 will lower the self-induced vibration by the VCM and improve the shock performance of the drive. The reduction in self-induced vibration by the VCM will in turn reduce seeking sound emission through the base of the drive.

FIG. 5A is a side view of a self-adhesive damper according to one embodiment of the present invention. In this example damper 500 comprises a thin, flat backing film 501, a plurality of contact points 502 extending above the backing film 501, an adhesive layer 503, and a liner 504.

As illustrated in this example, the plurality of contact points 502 appear as a number of bumps or dome-shaped protuberances. However, the exact shape of the contact points 502 may vary significantly. Alternative embodiments may utilize contact points 502 that are not dome shaped. For example, contact points 502 extending from the backing film of the self-adhesive damper 500 may be oblong, oval, rib-like, etc.

According to one embodiment of the present invention, the plurality of contact points 501 are made of Form In Place Gasket (FIPG) material deposited onto the backing film in a liquid form 501 and then cured. Materials used to form the contact points 502 may include any of a variety of FIPG materials with characteristics suitable for use to dampen vibrations in an environment and at temperatures common in a disc drive. Suitable characteristics include cleanliness and low outgassing, a high loss factor, and stiffness. A suitable range for loss factor may include a loss factor of greater than 0.75 at a temperature from 25 to 37 degrees Celsius. Suitable stiffness may be considered a compression modulus from 1 to 3 MPa. Examples of FIPG materials considered suitable for use to form contact points 502 include, but are not limited to silicons, urethanes, etc.

The plurality of contact points 502 are deposited onto and are affixed to the top of a thin backing film 501. The backing film 501 may be made of material with characteristics similar to those discussed above. To reiterate, these characteristics include cleanliness and low outgassing, a high loss factor, and stiffness. Additionally, the backing film 501 should be capable of withstanding the temperature required to cure the FIPG material when forming the contact points 502. Materials considered to be suitable for use as the backing film include, but are not limited to various polyesters, nylon, polyamides, polyimides, Kapton®, etc.

The backing film 501 has a thin, pressure-sensitive adhesive layer 503 applied to the bottom. The adhesive layer may be made of any type of pressure-sensitive adhesive that is able to maintain its adhesive qualities at temperature ranges normally experienced inside of a disc drive. Additionally, the adhesive layer 503 should be capable of withstanding the temperature required to cure the FIPG material when forming the contact points 502.

A liner 504 is in turn applied to the adhesive layer 503 to protect the adhesive layer 503 until the damper 500 is installed. This liner 504 will be removed from the damper 500 to expose the adhesive layer 503 prior to installation of the damper 500. The liner may be made of any type of paper, plastic, or other material suitable to protect the adhesive layer 503 without permanently adhering to the adhesive layer 503.

According to one embodiment of the present invention, the self-adhesive damper may be made by depositing liquid FIPG materials onto sheet of backing film with an adhesive layer and liner. The FIPG material is then cured at a temperature and for a time appropriate for the type of material used. The completed self-adhesive dampers are then cut or punched out of the sheet of backing film.

FIG. 5B is a bottom view of a self-adhesive damper according to one embodiment of the present invention. This example illustrates one possible shape for the backing film 501 of the self-adhesive damper 500. Here, the backing film 501 of the self-adhesive damper 500 is shaped to conform to the shape of the surface of the VCM to which the self-adhesive damper 500 will be applied. For example, if the self-adhesive damper 500 is to be installed between the upper magnetic plate 140 and the cover 104 of the disc drive 100, the backing film 501 of the self-adhesive damper 500 may be shaped and sized to conform to the top surface of the upper magnetic plate 140. However, the exact size and shape of the backing film 501 of the self-adhesive damper 500 may vary significantly depending on cost, manufacturing, and other concerns.

The plurality of contact points 502 can be seen distributed across the top of the backing film 501. As discussed above, even though the contact points are shown here to be dome-shaped, it is conceived that other shapes may be utilized. Additionally, the location and spacing of the contact points 502 may vary significantly. According to one embodiment of the present invention, the contact points 502 are placed arbitrarily and randomly across the top of the backing film 501 of the self-adhesive damper 500. Alternatively, the contact points 502 may be located at even intervals with a fixed spacing between each.

FIG. 6 is a cross-sectional side view of a Voice Coil Motor (VCM) assembly mounted in an assembled disc drive with an installed self-adhesive damper according to one embodiment of the present invention. In this example a base deck 102, a lower magnetic plate 242, an upper magnetic plate 140, and a cover 104 are shown. The lower magnetic plate 242 is mounted on top of bosses 222 extending from the base plate 102. Mounted on the lower magnetic plate 242 is the permanent magnet pair 128. The upper magnetic plate 140 is mounted on top of the lower magnetic plate 242. Screws 216 pass through the upper magnetic plate 140 and the lower magnetic plate 242 and engage complementary threads (not shown) inside the bosses 222 to secure the upper magnetic plate 140 and the lower magnet plate 242 to the base deck 102. The cover 104 will mate with the base deck 102 at its edges (not shown) to seal the assembled disc drive 100. Typically the cover 104, when installed on the assembled disc drive 100, will be in close proximity to the top of the upper magnetic plate 140.

Additionally, the example illustrated in FIG. 6 shows a self-adhesive damper 500 according to one embodiment of the present invention. The self-adhesive damper is shown positioned between and contacting the upper magnetic plate 140 and the cover 104. In this example, the self-adhesive damper 500 is shown adhered to the upper magnetic plate 140. That is, the self-adhesive damper 500 has been applied to the upper magnetic plate 140 before the cover 104 was installed. Alternatively, the self-adhesive damper 500 may be applied to the inside of the cover 104 in a position over the upper magnetic plate 140 prior to the cover 104 being installed.

In the example illustrated in FIG. 6, only one self-adhesive damper 500 is used between the upper magnetic plate 140 and the cover 104. Alternatively, the self-adhesive damper 500 may be used between the lower magnetic plate 242 and the base deck 102. This self-adhesive damper may be adhered to the bottom of the lower magnetic plate 242. Alternatively, this self-adhesive damper may be adhered to the top of the base deck 102 between the bosses 222.

According to another embodiment of the present invention, more than one self-adhesive damper may be used in one disc drive. For example, one self-adhesive damper may be applied between the upper magnetic plate 140 and the cover 104, adhered to either the upper magnetic plate 140 or the cover 104, and one self-adhesive damper may be applied between the lower magnetic plate 242 and the base deck 102 adhered to either the lower magnetic plate 242 or the base deck 102 between the bosses 222. Using two self-adhesive dampers, one between the upper magnetic plate 140 and the cover 104 and one between the lower magnetic plate 242 and the base deck 102 may improve shock performance of the assembled drive. Therefore, using two self-adhesive dampers may be especially useful for disc drives installed in mobile devices.

Additionally, a self-adhesive damper may be used in combination with another type of damper including those disclosed herein. For example, a self-adhesive damper may be used in combination with a molded damper discussed above with reference to FIGS. 3 and 4 or with another alternative discussed below with reference to FIGS. 7 and 8.

According to one embodiment of the present invention, the self-adhesive damper may also be used to isolate the lower magnet plate 242 from the base deck 102 by extending across the bosses 222 rather than between the bosses 222. In this embodiment, the self-adhesive damper will be compressed between the lower magnetic plate 242 and the top of the bosses 222. Such isolation of the VCM from the bosses 222 and base deck 102 will lower the self-induced vibration by the VCM and improve the shock performance of the drive. The reduction in self-induced vibration by the VCM will in turn reduce seeking sound emission through the base of the drive.

FIG. 7 is a bottom view of a disc drive cover with a plurality of contact points comprising a damper according to one embodiment of the present invention. This example illustrates the inside or bottom of a disc drive cover 104. Visible in this view is a seal area 701. Prior to the cover 104 being installed on a disc drive, a bead of FIPG material will be applied to the seal area 701. The bead of FIPG material will then be cured to form a gasket to seal the cover 104 to the disc drive when installed.

Also visible is the VCM area 700 that is the area that will be directly above the VCM when the cover 104 is installed on the disc drive. According to one embodiment of the present invention, a plurality of contact points 703 may be formed in the VCM area 700. That is, when the bead of FIPG material is applied to the seal area 701 of the cover 104, FIPG material may also be deposited onto the cover 104 in the VCM area 700 to form a plurality of contact points 703. The contact points 703 are then cured along with the bead of FIPG material in the seal area 701. The FIPG material used may be any suitable material as discussed previously.

The plurality of contact points 703 can be seen distributed across the VCM area 700. As discussed above, even though the contact points are shown here to be dome-shaped, it is conceived that other shapes may be utilized. Additionally, the location and spacing of the contact points 703 may vary significantly. According to one embodiment of the present invention, the contact points 703 are placed arbitrarily and randomly across the VCM area 700 of the cover 104. Alternatively, the contact points 703 may be located at even intervals with a fixed spacing between each.

FIG. 8 is a cross sectional side view of a Voice Coil Motor (VCM) assembly mounted in an assembled disc drive with a plurality of contact points comprising a damper according to one embodiment of the present invention. In this example a base deck 102, a lower magnetic plate 242, an upper magnetic plate 140, and a cover 104 are shown. The lower magnetic plate 242 is mounted on top of bosses 222 extending from the base plate 102. Mounted on the lower magnetic plate 242 is the permanent magnet pair 128. The upper magnetic plate 140 is mounted on top of the lower magnetic plate 242. Screws 216 pass through the upper magnetic plate 140 and the lower magnetic plate 242 and engage complementary threads (not shown) inside the bosses 222 to secure the upper magnetic plate 140 and the lower magnet plate 242 to the base deck 102. The cover 104 will mate with the base deck 102 at its edges (not shown) to seal the assembled disc drive 100. Typically the cover 104, when installed on the assembled disc drive 100, will be in close proximity to the top of the upper magnetic plate 140.

Additionally, the example illustrated in FIG. 8 shows a plurality of contact points 703 comprising a damper according to one embodiment of the present invention. The plurality of contact points are shown deposited on and affixed to the cover 104 and contacting the upper magnetic plate 140. As discussed above, even though the contact points are shown here to be dome-shaped, it is conceived that other shapes may be utilized. Additionally, the location and spacing of the contact points 703 may vary significantly. According to one embodiment of the present invention, the contact points 703 are placed arbitrarily and randomly across the VCM area 700 of the cover 104. Alternatively, the contact points 703 may be located at even intervals with a fixed spacing between each.

Thus, the present invention provides an improvement over prior dampers which rely on simple blocks of dampening material. This is because such prior art dampers provide only localized effects since they are not distributed across a VCM. The present invention solves this problem by providing a damper with a plurality of contact points distributed across a VCM.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the size and shape of the contact points may vary significantly. Additionally, the location and spacing of the contact points may vary significantly. Numerous other changes may be made which will readily suggest themselves to those skilled in the art and which are encompassed in the spirit of the invention disclosed and as defined in the appended claims.

1. A disc drive comprising:
a base deck having an upper surface;
a cover having an inside surface, the cover mounted on the base deck above the upper surface of the base deck;
a Voice Coil Motor (VCM) mounted on the upper surface of the base deck and below the cover, the VCM comprising a lower magnetic plate mounted on a plurality of bosses extending above the upper surface of the base deck and an upper magnetic plate mounted on the lower magnetic plate, the upper magnetic plate having an upper surface; and
a damper positioned between the upper surface of the upper magnetic plate of the VCM and the inside surface of the cover, the damper comprising a plurality of contact points distributed across the upper surface of the upper magnetic plate, the plurality of discrete contact points to extend between the upper surface of the upper magnetic plate of the VCM and the inside surface of the cover.

2. The disc drive of claim 1, wherein the damper further comprises a base section with the plurality of contact points supported by the base section.

3. The disc drive of claim 2, wherein the base section of the damper is applied to the upper surface of the upper magnetic plate and the plurality of contact points extend to the inside surface of the cover.

4. The disc drive of claim 2, wherein the damper is formed from a high loss factor elastomer.

5. The disc drive of claim 1, wherein the damper further comprises a backing film with the plurality of contact points affixed to the backing film to form a single piece.

6. The disc drive of claim 5, wherein the plurality of contact points are formed from Form In Place Gasket (FIPG) material deposited onto an upper surface the backing film.

7. The disc drive of claim 5, further comprising an adhesive layer on a lower surface of the backing film.

8. A distributed damper for dampening vibrations in a disc drive, the damper comprising:
a base; and
a plurality of discrete contact points distributed across the base, the plurality of contact points to extend and provide contact between the a Voice Coil Motor (VCM) of the disc drive and another component of the disc drive.

9. The distributed damper of claim 8, wherein the base and the plurality of contact points are molded to form a single piece.

10. The distributed damper of claim 9, wherein the distributed damper is formed from a high loss factor elastomer.

11. The distributed damper of claim 8, wherein the base further comprises a backing film with the plurality of contact points affixed to the backing film to form a single piece.

12. The distributed damper of claim 11, wherein the plurality of contact points are formed from Form In Place Gasket (FIPG) material deposited onto an upper surface of the backing film.

13. The distributed damper of claim 11, wherein the backing film has an adhesive layer on a lower surface of the backing film.

14. A method of forming a distributed damper for a disc drive, the method comprising:
depositing liquid Form In Place Gasket (FIPG) material onto a surface to form a plurality of contact points, the plurality of contact points providing contact between a Voice Coil Motor (VCM) of the disc drive and another component of the disc drive; and
curing the liquid FIPG material to form a solid damper.

15. The method of claim 14, wherein the FIPG material is deposited onto an inside surface of a cover of the disc drive in an area above the VCM when the cover is installed on the disc drive.

16. The method of claim 14, wherein the FIPG material is deposited onto a backing film, the backing film having a pressure-sensitive adhesive layer on a bottom side of the backing film.

17. The method of claim 16, further comprising after curing the liquid FIPG material, affixing the damper to an upper magnetic plate of the VCM via the pressure-sensitive adhesive layer.

18. The method of claim 14, further comprising after curing the liquid FIPG material, positioning the damper between a lower surface of a lower magnetic plate of the VCM and an upper surface of a base plate of the disc drive.

19. The method of claim 16, further comprising affixing the damper to the lower surface of the lower magnetic plate via the pressure sensitive adhesive layer.

20. The method of claim 18, further comprising affixing the damper to the upper surface of the base deck via the pressure sensitive adhesive layer.
